(19) United States
(12) Patent Application Publication
(10) Pub. No.: US 2015/0367715 A1
(43) Pub. Date: Dec. 24, 2015

(54) VEHICLE DOOR STRUCTURE

(71) Applicant: TOYOTA JIDOSHA KABUSHIKI KAISHA, Toyota-shi, Aichi (JP)

(72) Inventor: Yoshiteru INAMOTO, Toyota-shi (JP)

(21) Appl. No.: 14/766,889

(22) PCT Filed: Feb. 4, 2014
(86) PCT No.: PCT/JP2014/052987

§ 371 Date: Aug. 10, 2015

(30) Foreign Application Priority Data
Feb. 22, 2013 (JP) 2013-033499

(51) Int. Cl. B60J 5/04

(52) U.S. Cl. CPC B60J 5/0456; B60J 5/0437; B60J 5/0443; B60J 5/045; B60J 5/0455

(57) ABSTRACT

A vehicle door structure includes a door outer panel that configures an outer plate of a side door; a door inner panel that is provided towards a vehicle width direction inside than the door outer panel, and that configures an inner plate of the side door; an impact beam disposed between the door outer panel and the door inner panel so as to run along the side door in the vehicle front-rear direction; and a bracket that is provided with an excess length portion between a first joint portion that is joined to a vehicle front-rear direction front portion of the door inner panel and a second joint portion that is joined to a vehicle front-rear direction front portion of the impact beam, with an apex portion of the excess length portion provided towards the vehicle width direction inside than the vehicle width direction position of the second joint portion.

### TECHNICAL FIELD

The present invention relates to a vehicle door structure.

### BACKGROUND ART

Technology exists in which an impact beam running along a vehicle front-rear direction is fixed through a bracket inside a vehicle door, enabling collision energy to be absorbed by a reaction force obtained from the impact beam (see for example Japanese Patent Application Laid-Open (JP-A) No. 2007-203895).

Patent Document: JP-A No. 2007-203895

However, although collision energy is absorbed by a reaction force from the impact beam in the event of a collision load being input to the impact beam, a sufficient reaction force cannot be obtained from the impact beam if a bracket breaks during the process.

### SUMMARY OF INVENTION

### Technical Problem

In consideration of the above circumstances, an object of the present invention is to provide a vehicle door structure that can suppress breakage of a bracket.

### Solution to Problem

A vehicle door of a first aspect of the present invention includes: a door outer panel that configures an outer plate of a side door; a door inner panel that is provided further towards a vehicle width direction inside than the door outer panel, and that configures an inner plate of the side door; an impact beam disposed between the door outer panel and the door inner panel so as to run along the side door in the vehicle front-rear direction; and a bracket that is provided with an excess length portion between a first joint portion that is joined to a vehicle front-rear direction front portion of the door inner panel and a second joint portion that is joined to a vehicle front-rear direction front portion of the impact beam, with an apex portion of the excess length portion provided further towards the vehicle width direction inside than the vehicle width direction position of the second joint portion.

In the vehicle door structure of the first aspect of the present invention, the impact beam is disposed so as to run along the side door in the vehicle front-rear direction between the door outer panel that configures the outer plate of the side door, and the door inner panel that configures the inner plate of the side door. The vehicle front-rear direction front portion of the door inner panel is joined at the vehicle front-rear direction front portion of the impact beam through the bracket.

The excess length portion is provided to the bracket between the first joint portion that is joined to the door inner panel, and the second joint portion that is joined to the impact beam. Namely, the length of the excess length portion can be made longer than that of a wall portion formed so as to connect in a straight line between the first joint portion and the second joint portion.

For example, the impact beam is deformed towards the vehicle width direction inside when a collision load is input to the side door and the collision energy is absorbed by reaction force of the impact beam. When this occurs, the reaction force of the impact beam can be maintained due the excess length portion provided to the bracket extending.

The apex portion of the excess length portion is provided further towards the vehicle width direction inside than the vehicle width direction position of the second joint portion. Namely, the length of the excess length portion can be made longer than when the apex portion of the excess length portion is provided in a region at a position between the wall portion formed so as to connect in a straight line between the first joint portion and the second joint portion and a straight line that is on an extension line of the second joint portion. The deformation amount of the impact beam toward the vehicle width direction inside can thereby be increased and a sufficient reaction force can be obtained from the impact beam.

A vehicle door structure of a second aspect of the present invention is the vehicle door structure of the first aspect, wherein the excess length portion is formed such that it has a bend towards the vehicle width direction inside that is centered about the apex portion.

In the vehicle door structure of the second aspect of the present invention, the excess length portion is formed with a bend centered about the apex portion, thereby enabling the position of the apex portion of the excess length portion to be provided further towards the vehicle width direction inside, and the length of the excess length portion to be made longer, than when the excess length portion is formed as a curve.

A vehicle door of a third aspect of the present invention is the vehicle door structure of the second aspect, wherein: the excess length portion is configured so as to include a front wall portion that is provided at a vehicle front-rear direction front side of the apex portion, and that connects in a straight line between a vehicle front-rear direction rear end portion of a first seat portion, formed to the first joint portion running along the vehicle front-rear direction and along the vehicle up-down direction, and the apex portion, and a rear wall portion that is provided at a vehicle front-rear direction rear side of the apex portion and that connects in a straight line between a vehicle front-rear direction front end portion of a second seat portion formed to the second joint portion, running along the vehicle front-rear direction and the vehicle up-down direction, and the apex portion; and an angle (β) formed on the apex portion side between the front wall portion and a hypothetical line running between the first joint portion and the second joint portion is set to be greater than an angle (α) formed between the hypothetical line and the first seat portion.

In the vehicle door structure of the third aspect of the present invention, the first seat portion is formed to the first joint portion of the bracket running in the vehicle front-rear direction and in the vehicle up-down direction and the second seat portion is formed to the second joint portion running in the vehicle front-rear direction and in the vehicle up-down direction. The excess length portion is configured so as to include the front wall portion provided at the vehicle front-rear direction front side of the apex portion, and the rear wall portion provided at the vehicle front-rear direction rear side of the apex portion. Specifically, the front wall portion is formed connecting in a straight line between the vehicle front-rear direction rear end portion of the first seat portion and the apex portion, and the rear wall portion is formed connecting in a straight line between the apex portion and the vehicle front-rear direction front end portion of the second seat portion.

In the present invention, the angle (β) formed on the apex portion side between the front wall portion and a hypothetical line running between the first joint portion and the second joint portion is set to be greater than the angle (α) formed between the hypothetical line and the first seat portion. The apex portion of the excess length portion can thus be provided at a position further towards the vehicle width direction inside than when the angle (β) formed on the apex portion side between the front wall portion and the hypothetical line is set to be smaller than the angle (α) formed between the hypothetical line and the first seat portion (β<α). The length of the excess length portion can accordingly be made even longer.

### Advantageous Effects of Invention

The vehicle door structure of the first aspect of the present invention has the excellent advantageous effect of enabling breakage of the bracket to be suppressed.

The vehicle door structure of the second aspect of the present invention has the excellent advantageous effect of enabling the length of the excess length portion to be made longer than when the excess length portion is formed as a curve.

The vehicle door structure of the third aspect of the present invention has the excellent advantageous effect of being able to further suppress breakage of the bracket due to the excess length portion being able to extend further during absorption of collision energy by the impact beam.

### BRIEF DESCRIPTION OF DRAWINGS

FIG. 1 is an enlarged cross-section view illustrating a front side door applied with a vehicle door structure of an exemplary embodiment viewed in a cut-away state along line 1-1 in FIG. 2;

FIG. 2 is a partial enlarged view illustrating portion A in FIG. 5 of a front side door applied with a vehicle door structure of an exemplary embodiment in an enlarged state;

FIG. 3 is an explanatory drawing to explain a portion of a configuration of a bracket in a front side door applied with a vehicle door structure of an exemplary embodiment, and is an enlarged cross-section corresponding to FIG. 2;

FIG. 4 is an enlarged cross-section corresponding to FIG. 2 illustrating a state in which an impact load has been input to a front side door applied with a vehicle door structure of an exemplary embodiment;

FIG. 5 is a side view as viewed from the vehicle outside, illustrating a state in which a door outer panel has been removed in a front side door applied with a vehicle door structure of an exemplary embodiment.

### DESCRIPTION OF EMBODIMENTS

A vehicle door structure of an exemplary embodiment of the present invention is described below with reference to the drawings. Note that in each of the drawings, the arrow FR, the arrow UP and the arrow IN respectively indicate the vehicle front direction, the vehicle upper direction, and the vehicle width direction inside as appropriate.

### Vehicle Door Structure Configuration

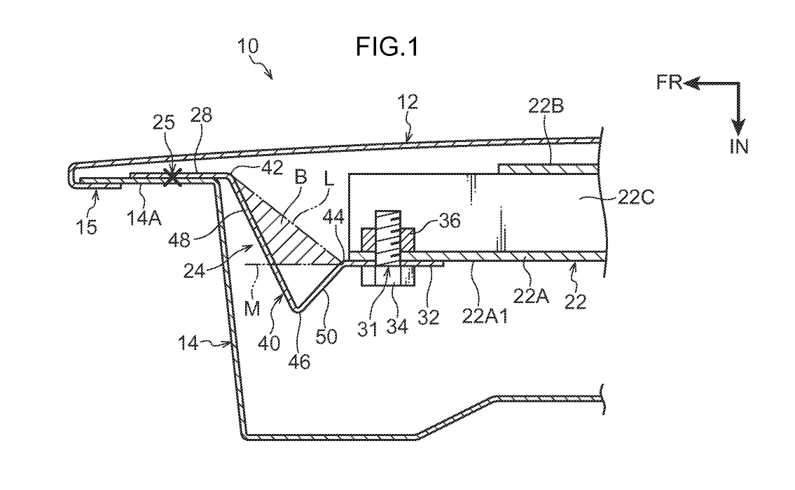

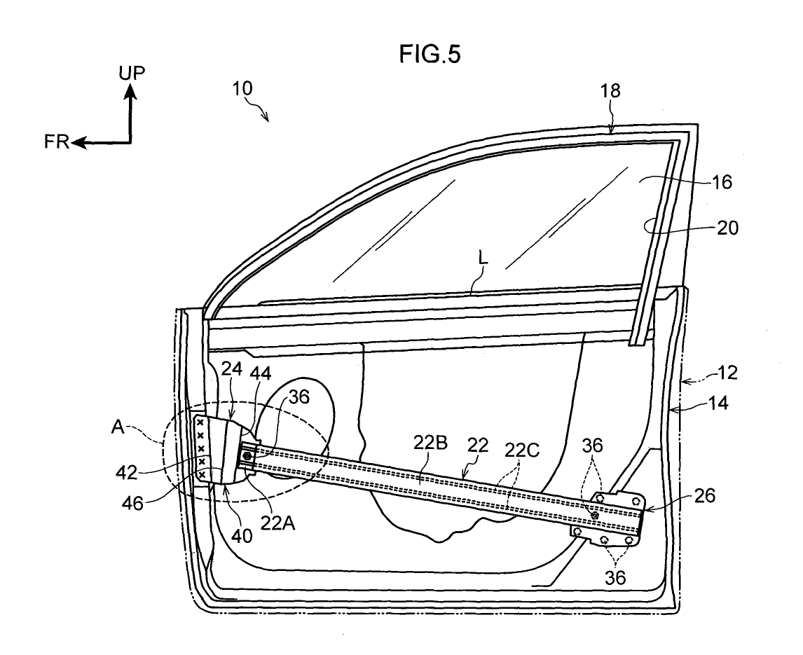

FIG. 1 and FIG. 5 illustrate a front side door 10 (hereafter referred to simply as the “side door”) applied with the vehicle door structure. A door outer panel 12 that configures an outer plate of the side door 10 and that is exposed at the vehicle outside is disposed at the vehicle width direction outside of the side door 10. A door inner panel 14 that configures an inner plate of the side door 10 is disposed at the vehicle width direction inside of the door outer panel 12.

The door outer panel 12 and the door inner panel 14 are joined together by for example a hemming process (hemming processed portion 15) in a state configuring a closed cross-section. A window regulator that is not illustrated in the drawings is provided between the door outer panel 12 and the door inner panel 14. The window regulator enables door glass 16 (see FIG. 5) to move up and down between the door outer panel 12 and the door inner panel 14.

As illustrated in FIG. 5, a door frame 18 is provided at an upper portion of the side door 10. The door frame 18 is formed in an inverted U-shape that is open downwards in the vehicle up-down direction (vehicle direction downwards). The door frame 18 is attached to the door inner panel 14, and an opening portion 20 is formed between an upper edge portion (referred to as the belt line L) of the door inner panel 14 and the door frame 18. The opening portion 20 is opened and closed by up and down movement of the door glass 16.

As illustrated in FIG. 1 and FIG. 5, an impact beam 22 is provided running in the vehicle front-rear direction between the door outer panel 12 and the door inner panel 14. The impact beam 22 is attached to the door inner panel 14 in a state in which the impact beam 22 inclines downwards in the vehicle up-down direction on progression towards the vehicle front-rear direction rear side.

The impact beam 22 is for example formed with an angular cross-section profile as taken along the vehicle width direction. An inner wall portion 22A configured with an elongated shape running in the vehicle front-rear direction is provided at the vehicle width direction inside of the impact beam 22. An outer wall portion 22B configured with an elongated shape running in the vehicle front-rear direction is further provided at the vehicle width direction outside of the impact beam 22. A pair of ribs 22C that extend along the vehicle front-rear direction span between the inner wall portion 22A and the outer wall portion 22B.

As illustrated in FIG. 5, a vehicle front-rear direction front portion and a vehicle front-rear direction rear portion of the impact beam 22 are respectively joined to a bracket 24 and a bracket 26. The brackets 24, 26 are each joined to the door inner panel 14, with the impact beam 22 joined and fixed to the door inner panel 14 through the brackets 24, 26.

More specifically, the vehicle front-rear direction front portion of the impact beam 22 is fixed to a vehicle front-rear direction front portion and a vehicle up-down direction central portion of the door inner panel 14 through the bracket 24, and the vehicle front-rear direction rear portion of the impact beam 22 is fixed to a vehicle front-rear direction rear portion and a vehicle up-down direction lower side of the door inner panel 14 through the bracket 26.

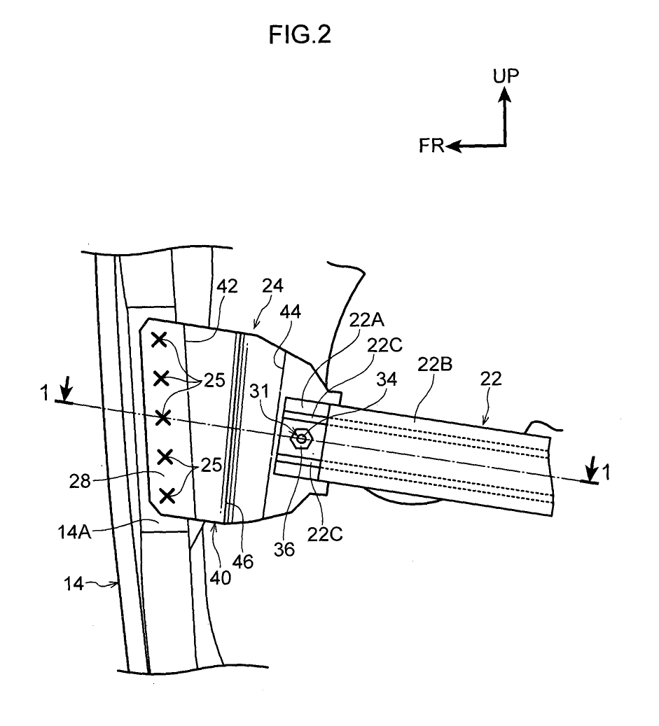

As illustrated in FIG. 1 and FIG. 2, the bracket 24 is formed with a plate shape, for example by press processing. A seat portion 28 that serves as a first seat portion is formed running, in a straight line, along the vehicle front-rear direction and the vehicle up-down direction at a vehicle front-rear direction front portion of the bracket 24 at a joint portion 25, indicated by crosses, serving as a first joint portion. The seat portion 28 is configured so as to be capable of contacting a seat face portion 14A provided at the vehicle front-rear direction front portion of the door inner panel 14. The seat portion 28 is joined by welding to the door inner panel 14 at the joint portion 25 using spot welding in a state in which the seat portion 28 is in contact with the seat face portion 14A.

A seat portion 32 that serves as a second seat portion and has a linear profile in the vehicle front-rear direction and the vehicle up-down direction is formed at a vehicle front-rear direction rear portion of the bracket 24 at joint portion 31 serving as a second joint portion (over the axial lines of bolts 34, described later). The seat portion 32 is configured so as to be capable of contacting a vehicle width direction inner face 22A1 side of the inner wall portion 22A of the impact beam 22. The seat portion 32 is joined by fastening to the impact beam 22 at the joint portion 31 by the bolts 34 and the nuts 36 in a state in which the seat portion 32 is in contact with the inner face 22A1 of the inner wall portion 22A.

As shown in FIG. 5, the door inner panel 14 and the impact beam 22 are joined together by respectively fastening through for example bolts (see FIG. 1) and nuts 36 at the bracket 26 side.

More detailed explanation follows regarding the bracket 24. As illustrated in FIG. 1, the bracket 24 of the present exemplary embodiment is provided with an excess length portion 40 between the seat portion 28 and the seat portion 32. The excess length portion 40 is formed so as to be longer than a base length when a straight line L running between a vehicle front-rear direction rear end portion (a ridge line 42) of the seat portion 28 and a vehicle front-rear direction front end portion (a ridge line 44) of the seat portion 32 is taken as the base length. Furthermore, in the present exemplary embodiment an apex portion 46 (ridge line) of the excess length portion 40 is provided further towards the vehicle width direction inside than the vehicle width direction position of a straight line M that is an extension line of the seat portion 32.

The excess length portion 40 is formed with a bend towards the vehicle width direction inside centered about the apex portion 46 (the excess length portion 40 is formed so as to be substantially V-shaped in plan view). A front wall portion 48 is formed running along the vehicle up-down direction between the apex portion 46 and the vehicle front-rear direction rear end portion (the ridge line 42) of the seat portion 28 (the vehicle front-rear direction front side of the apex portion 46), so as to connect in a straight line between the apex portion 46 and the vehicle front-rear direction rear end portion of the seat portion 28. A rear wall portion 50 is formed running along the vehicle up-down direction between the apex portion 46 and the vehicle front-rear direction front end portion (the ridge line 44) of the seat portion 32 (at the vehicle front-rear direction rear side of the apex portion 46), so as to connect in a straight line between the apex portion 46 and the vehicle front-rear direction front end portion of the seat portion 32.

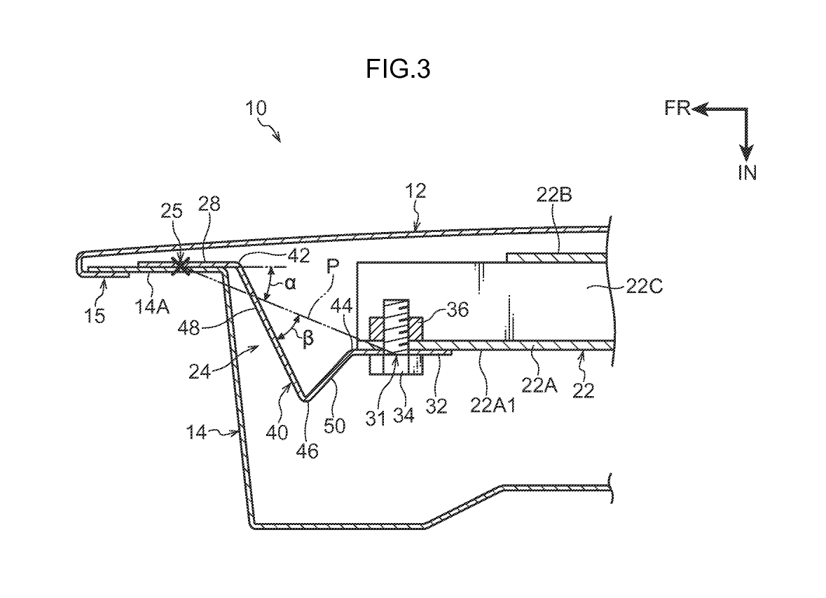

Moreover, as illustrated in FIG. 3, an angle (β) formed on the apex portion 46 side between a hypothetical line P, running between the joint portion 25 of the seat portion 28 and the joint portion 31 of the seat portion 32, and the front wall portion 48, is set to be greater than an angle (α) formed between the hypothetical line P and the seat portion 28 (β>α).

### Operation and Advantageous Effects of the Vehicle Door Structure

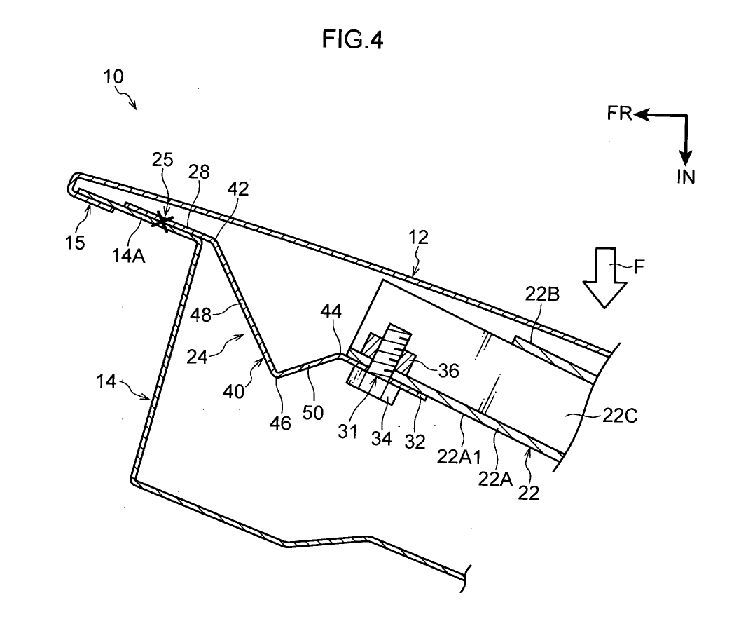

As illustrated in FIG. 1, in the present exemplary embodiment the bracket 24 that is joined to a vehicle front-rear direction front portion of the impact beam 22 is provided with the excess length portion 40 between the seat portion 28 and the seat portion 32. As illustrated in for example FIG. 4, when a collision load F is input to the side door 10 and the collision energy is absorbed by a reaction force of the impact beam 22, the impact beam 22 is heavily deformed (referred to as large deformation) towards the vehicle width direction inside. When this occurs, reaction force of the impact beam 22 can be maintained due to extending of the excess length portion 40 provided to the bracket 24.

As illustrated in FIG. 1, in the present exemplary embodiment the apex portion 46 of the excess length portion 40 is provided further towards the vehicle width direction inside than the vehicle width direction position of the straight line M that is on an extension line of the seat portion 32. Although not illustrated in the drawings, the length of the excess length portion 40 can therefore be made longer than when the apex portion 46 of the excess length portion 40 is provided in a region B at a position between the straight line L that runs between the vehicle front-rear direction rear end portion (the ridge line 42) of the seat portion 28 and the vehicle front-rear direction front end portion (the ridge line 44) of the seat portion 32 and the straight line M that is on an extension line of the seat portion 32. The deformation amount of the impact beam 22 towards the vehicle width direction inside can thus be increased, enabling sufficient reaction force to be obtained from the impact beam 22. Namely, breakage of the bracket 24 can be suppressed.

As described above, in the present exemplary embodiment the excess length portion 40 is formed with a bend towards the vehicle width direction inside centered about the apex portion 46, and the front wall portion 48 is formed running along the vehicle up-down direction at the vehicle front-rear direction front side of the apex portion 46 so as to connect in a straight line between the apex portion 46 and the vehicle front-rear direction rear end portion of the seat portion 28. The rear wall portion 50 is moreover formed running along the vehicle up-down direction at the vehicle front-rear direction rear side of the apex portion 46 so as to connect in a straight line between the apex portion 46 and the vehicle front-rear direction front end portion of the seat portion 32.

Consequently, although not illustrated in the drawings, bending the excess length portion 40 about the apex portion 46 enables the apex portion of the excess length portion to be provided at a position further towards the vehicle width direction inside than when the excess length portion is formed as a curve (when the excess length portion is formed substantially U-shaped in plan view), and the length of the excess length portion can be made longer. However, the present invention does not preclude forming the excess length portion with a curve.

Moreover, as illustrated in FIG. 3, in the present exemplary embodiment the angle (β) formed on the apex portion 46 side between the hypothetical line P, that runs between the joint portion 25 of the seat portion 28 and the joint portion 31 of the seat portion 32, and the front wall portion 48, is set to be greater than the angle (α) formed between the hypothetical line P and the seat portion 28 (β>α).

The apex portion 46 of the excess length portion 40 can thus be provided at a position further towards the vehicle width direction inside than when the angle (β) formed on the apex portion 46 side between the front wall portion 48 and the hypothetical line P is set to be smaller than the angle (α) formed between the hypothetical line P and the seat portion 28 (β<α). The length of the excess length portion 40 can accordingly be made longer, and the excess length portion 40 can extend more during impact energy absorption by the impact beam 22. Breakage of the bracket 24 can accordingly be suppressed. However, the present invention does not preclude setting the angle β smaller than the angle α.

Note that in the present exemplary embodiment the impact beam 22 is formed with an angular cross-section as taken along the vehicle width direction, however the shape of the impact beam 22 is not particularly limited. The impact beam 22 may, for example, be formed with a pipe shape, and the shape of the impact beam 22 may be modified as appropriate for the materials used in the impact beam 22. Moreover, the method of joining the brackets 24, 26 to the impact beam 22 and the door inner panel 14 may be modified as appropriate.

In the present exemplary embodiment, explanation is given regarding an example of application as a front side door, however the present invention may also be applied as a rear side door.

One exemplary embodiment of the present invention has been described above, however, the present invention is not limited thereto, and obviously various modifications may be implemented within a range not departing from the spirit of the present invention. The disclosure of Japanese Patent Application No. 2013-033499, filed Feb. 22, 2013 is incorporated herein by reference in its entirety.

All publications, patent applications, and technical standards mentioned in this specification are herein incorporated by reference to the same extent as if each individual publication, patent application, or technical standard was specifically and individually indicated to be incorporated by reference.

1. A vehicle door structure comprising:
a door outer panel (12) that configures an outer plate of a side door (10);
a door inner panel (14) that is provided further towards a vehicle width direction inside than the door outer panel (12), and that configures an inner plate of the side door (10);
an impact beam (22) disposed between the door outer panel (12) and the door inner panel (14)so as to run along the side door (10) in the vehicle front-rear direction; wherein
a bracket (24) that is provided with an excess length portion (40) between a first joint portion (25) that is joined to a vehicle front-rear direction front portion of the door inner panel (14) and a second joint portion (31) that is joined to a vehicle front-rear direction front portion of the impact beam (22), with an apex portion (46) of the excess length portion provided further towards the vehicle width direction inside than the vehicle width direction position of the second joint portion (31), wherein
a ridge line of the apex portion (46) of the excess length portion (40) is provided further towards the vehicle width direction inside than the vehicle width direction position of a straight line (M) that is an extension line of a seat portion (32) of the bracket (24).

2. The vehicle door structure of claim 1, wherein the excess length portion (40) is formed so as to bend towards the vehicle width direction inside that is centered about the apex portion (46).

3. The vehicle door structure of claim 2, wherein:
the excess length portion (40) is configured so as to include:
a front wall portion (48) that is provided at a vehicle front-rear direction front side of the apex portion (24), and that connects, in a straight line, between a vehicle front-rear direction rear end portion of a first seat portion (28), formed to the first joint portion (25) running along the vehicle front-rear direction and along the vehicle up-down direction, with the apex portion (46), and
a rear wall portion (50) that is provided at a vehicle front-rear direction rear side of the apex portion (46) and that connects, in a straight line, a vehicle front-rear direction front end portion of a second seat portion (32) formed to the second joint portion (31), running along the vehicle front-rear direction and the vehicle up-down direction, with the apex portion (46); and
an angle (β) formed on the apex portion side between the front wall portion (48) and a hypothetical line running between the first joint portion (25) and the second joint portion (31) is set to be greater than an angle (a) formed between the hypothetical line and the first seat portion (28).
